(19) United States
(12) Patent Application Publication
(10) Pub. No.: US 2008/0077772 A1
(43) Pub. Date: Mar. 27, 2008

(54) Method and apparatus for performing select operations

(76) Inventors: Ronen Zohar, Sunnyvale, CA (US); Mohammad Abdallah, Folsom, CA (US); Boris Sabanin, N. Novgorod Region (RU); Mark Seconi, Beaverton, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/526,065

(22) Filed: Sep. 22, 2006

(51) Int. Cl. G06F 9/30

(52) U.S. Cl. 712/208; 712/220

(57) ABSTRACT

A method and apparatus for including in a processor instructions for performing select operations on packed or unpacked data. In one embodiment, a processor is coupled to a memory. The memory has stored therein first packed data in a source operand and a second packed data in a destination operand. The processor selects the first packed data if the control bit for the source operand is set to “1” and stores the data into the destination operand. Otherwise, the processor keeps the data in the destination operand. The final value of the destination operand is stored in memory.

### BACKGROUND OF THE DISCLOSURE

In typical computer systems, processors are implemented to operate on values represented by a large number of bits (e.g., 64) using instructions that produce one result. For example, the execution of an add instruction will add together a first 64-bit value and a second 64-bit value and store the result as a third 64-bit value. Multimedia applications (e.g., applications targeted at computer supported cooperation (CSC—the integration of teleconferencing with mixed media data manipulation), 2D/3D graphics, image processing, video compression/decompression, recognition algorithms and audio manipulation) require the manipulation of large amounts of data. The data may be represented by a single large value (e.g., 64 bits or 128 bits), or may instead be represented in a small number of bits (e.g., 8 or 16 or 32 bits). For example, graphical data may be represented by 8 or 16 bits, sound data may be represented by 8 or 16 bits, integer data may be represented by 8, 16 or 32 bits, and floating point data may be represented by 32 or 64 bits.

To improve efficiency of multimedia applications (as well as other applications that have the same characteristics), processors may provide packed data formats. A packed data format is one in which the bits typically used to represent a single value are broken into a number of fixed sized data elements, each of which represents a separate value. For example, a 128-bit register may be broken into four 32-bit elements, each of which represents a separate 32-bit value. In this manner, these processors can more efficiently process multimedia applications.

### BRIEF DESCRIPTION OF THE DRAWINGS

The present invention is illustrated by way of example and not limitation in the figures of the accompanying drawings.

FIGS. 1a-1c illustrate example computer systems according to alternative embodiments of the invention.

FIGS. 2a-2b illustrate register files of processors according to alternative embodiments of the invention.

FIG. 3 illustrates a flow diagram for at least one embodiment of a process performed by a processor to manipulate data.

FIG. 4 illustrates packed data types according to alternative embodiments of the invention.

FIG. 5 illustrates in-register packed byte and in-register packed word data representations according to at least one embodiment of the invention.

FIG. 6 illustrates in-register packed doubleword and in-register packed quadword data representations according to at least one embodiment of the invention.

FIG. 7 is a flow diagram illustrating an embodiment of a process for performing select operation.

FIG. 8 is a flow diagram illustrating an embodiment of a process for performing an immediate select operation.

FIGS. 9a-9c illustrate various embodiments of circuits for performing immediate select operations.

FIG. 10 is a flow diagram illustrating an embodiment of a process for performing variable select operations.

FIGS. 11a-11c illustrate various embodiments of circuits for performing variable select operations.

FIG. 12 is a block diagram illustrating various embodiments of operation code formats for processor instructions.

### DETAILED DESCRIPTION

Disclosed herein are embodiments of methods, systems and circuits for including in a processor instructions for performing select operations on multiple bits of data in response to a control signal. The data involved in the select operations may be packed or unpacked data. For at least one embodiment, a processor is coupled to a memory. The memory has stored therein a first datum and a second datum. The processor performs select operations on data elements in the first datum and the second datum in response to receiving an instruction and storing the results in the second datum based on the control signal.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims.

### Computer System

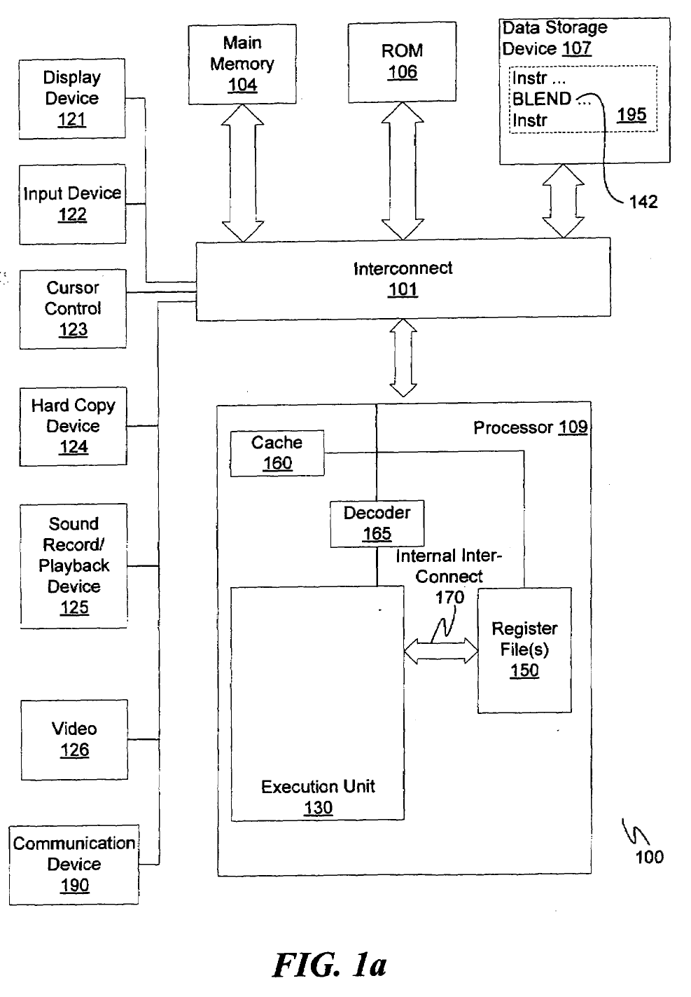

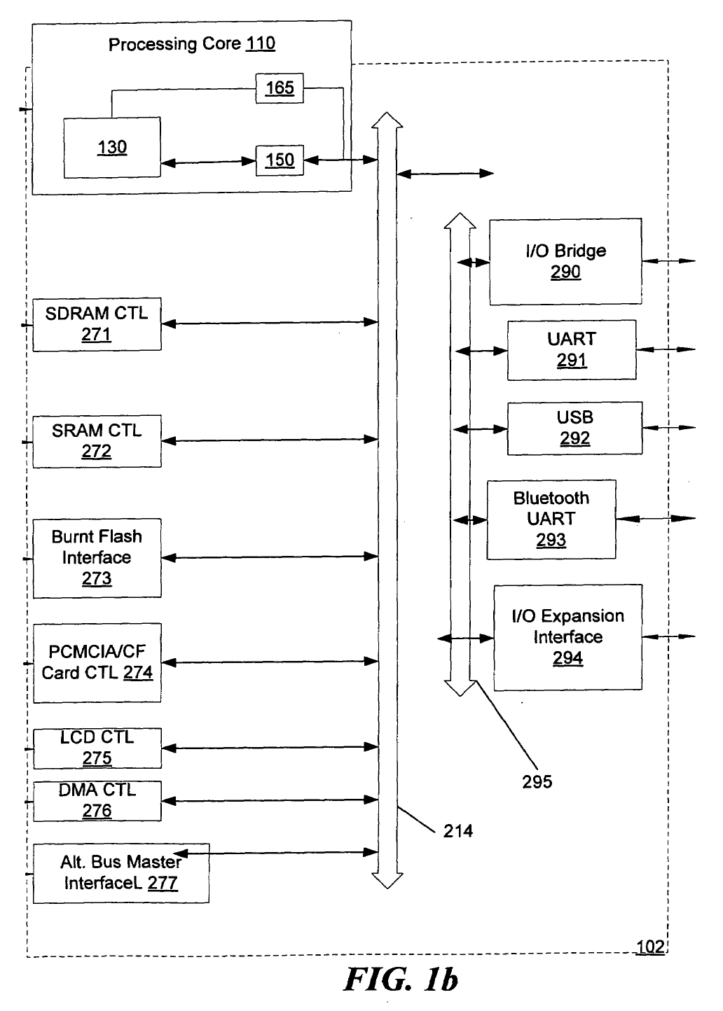

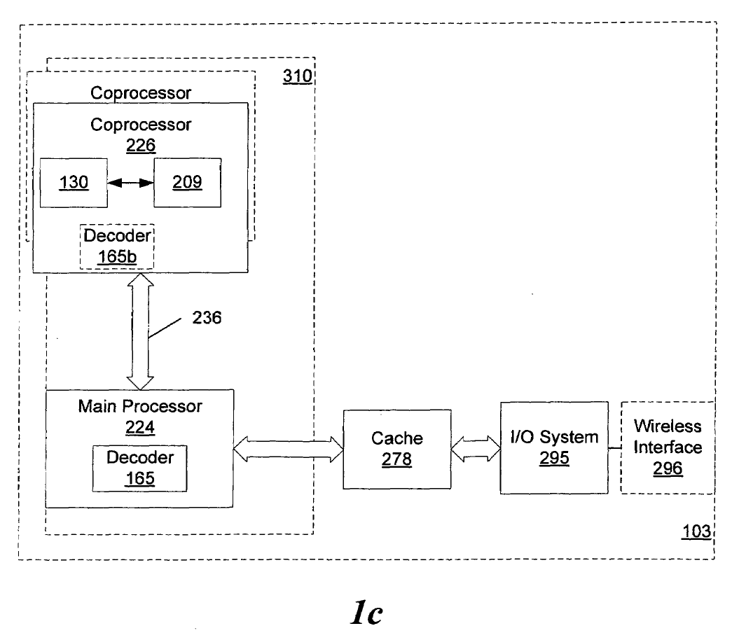

FIG. 1a illustrates an example computer system 100 according to one embodiment of the invention. Computer system 100 includes an interconnect 101 for communicating information. The interconnect 101 may include a multi-drop bus, one or more point-to-point interconnects, or any combination of the two, as well as any other communications hardware and/or software.

FIG. 1a illustrates a processor 109, for processing information, coupled with interconnect 101. Processor 109 represents a central processing unit of any type of architecture, including a CISC or RISC type architecture.

Computer system 100 further includes a random access memory (RAM) or other dynamic storage device (referred to as main memory 104), coupled to interconnect 101 for storing information and instructions to be executed by processor 109. Main memory 104 also may be used for storing temporary variables or other intermediate information during execution of instructions by processor 109.

Computer system 100 also includes a read only memory (ROM) 106, and/or other static storage device, coupled to interconnect 101 for storing static information and instructions for processor 109. Data storage device 107 is coupled to interconnect 101 for storing information and instructions.

FIG. 1a also illustrates that processor 109 includes an execution unit 130, a register file 150, a cache 160, a decoder 165, and an internal interconnect 170. Of course, processor 109 contains additional circuitry that is not necessary to understanding the invention.

Decoder 165 is for decoding instructions received by processor 109 and execution unit 130 is for executing instructions received by processor 109. In addition to recognizing instructions typically implemented in general purpose processors, decoder 165 and execution unit 130 recognize instructions, as described herein, for performing conditional copy operations (BLENDS) operations. The decoder 165 and execution unit 130 recognize instructions for performing BLEND operations on both packed and unpacked data.

Execution unit 130 is coupled to register file 150 by internal interconnect 170. Again, the internal interconnect 170 need not necessarily be a multi-drop bus and may, in alternative embodiments, be a point-to-point interconnect or other type of communication pathway.

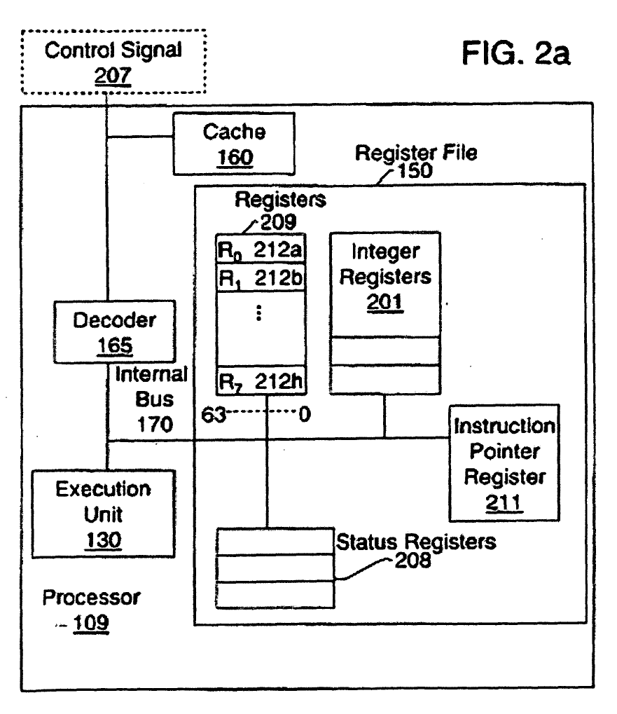

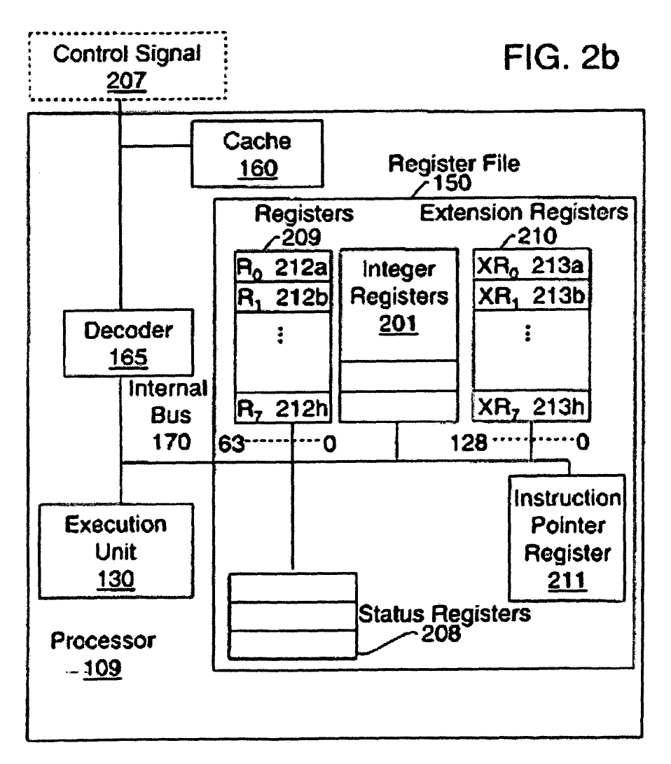

Register file(s) 150 represents a storage area of processor 109 for storing information, including data. It is understood that one aspect of the invention is the described instruction embodiments for performing BLEND operations on packed or unpacked data. According to this aspect of the invention, the storage area used for storing the data is not critical. However, embodiments of the register file 150 are later described with reference to FIGS. 2a-2b.

Execution unit 130 is coupled to cache 160 and decoder 165. Cache 160 is used to cache data and/or control signals from, for example, main memory 104. Decoder 165 is used for decoding instructions received by processor 109 into control signals and/or microcode entry points. These control signals and/or microcode entry points may be forwarded from the decoder 165 to the execution unit 130. In response to these control signals and/or microcode entry points, execution unit 130 performs the appropriate operations.

Decoder 165 may be implemented using any number of different mechanisms (e.g., a look-up table, a hardware implementation, a PLA, etc.). Thus, while the execution of the various instructions by the decoder 165 and execution unit 130 may be represented herein by a series of if/then statements, it is understood that the execution of an instruction does not require a serial processing of these if/then statements. Rather, any mechanism for logically performing this if/then processing is considered to be within the scope of the invention.

FIG. 1a additionally shows a data storage device 107 (e.g., a magnetic disk, optical disk, and/or other machine readable media) can be coupled to computer system 100. In addition, the data storage device 107 is shown to include code 195 for execution by the processor 109. The code 195 can include one or more embodiments of an BLEND instruction 142, and can be written to cause the processor 109 to perform bit testing with the BLEND instruction(s) 142 for any number of purposes (e.g., motion video compression/decompression, image filtering, audio signal compression, filtering or synthesis, modulation/demodulation, etc.).

Computer system 100 can also be coupled via interconnect 101 to a display device 121 for displaying information to a computer user. Display device 121 can include a frame buffer, specialized graphics rendering devices, a liquid crystal display (LCD), and/or a flat panel display.

An input device 122, including alphanumeric and other keys, may be coupled to interconnect 101 for communicating information and command selections to processor 109. Another type of user input device is cursor control 123, such as a mouse, a trackball, a pen, a touch screen, or cursor direction keys for communicating direction information and command selections to processor 109, and for controlling cursor movement on display device 121. This input device typically has two degrees of freedom in two axes, a first axis (e.g., x) and a second axis (e.g., y), which allows the device to specify positions in a plane. However, this invention should not be limited to input devices with only two degrees of freedom.

Another device that may be coupled to interconnect 101 is a hard copy device 124 which may be used for printing instructions, data, or other information on a medium such as paper, film, or similar types of media. Additionally, computer system 100 can be coupled to a device for sound recording, and/or playback 125, such as an audio digitizer coupled to a microphone for recording information. Further, the device 125 may include a speaker which is coupled to a digital to analog (D/A) converter for playing back the digitized sounds.

Computer system 100 can be a terminal in a computer network (e.g., a LAN). Computer system 100 would then be a computer subsystem of a computer network. Computer system 100 optionally includes video digitizing device 126 and/or a communications device 190 (e.g., a serial communications chip, a wireless interface, an ethernet chip or a modem, which provides communications with an external device or network). Video digitizing device 126 can be used to capture video images that can be transmitted to others on the computer network.

For at least one embodiment, the processor 109 supports an instruction set that is compatible with the instruction set used by existing processors (such as, e.g., the Intel® Pentium® Processor, Intel® Pentium® Pro processor, Intel® Pentium® II processor, Intel® Pentium® III processor, Intel® Pentium® 4 Processor, Intel® Itanium® processor, Intel® Itanium® 2 processor, or the Intel® Core™ Duo processor) manufactured by Intel Corporation of Santa Clara, Calif. As a result, processor 109 can support existing processor operations in addition to the operations of the invention. Processor 109 may also be suitable for manufacture in one or more process technologies and by being represented on a machine readable media in sufficient detail, may be suitable to facilitate said manufacture. While the invention is described below as being incorporated into an x86 based instruction set, alternative embodiments could incorporate the invention into other instruction sets. For example, the invention could be incorporated into a 64-bit processor using an instruction set other than the x86 based instruction set.

FIG. 1b illustrates an alternative embodiment of a data processing system 102 that implements the principles of the present invention. One embodiment of data processing system 102 is an applications processor with Intel XScale™ technology. It will be readily appreciated by one of skill in the art that the embodiments described herein can be used with alternative processing systems without departure from the scope of the invention.

Computer system 102 comprises a processing core 110 capable of performing BLEND operations. For one embodiment, processing core 110 represents a processing unit of any type of architecture, including but not limited to a CISC, a RISC or a VLIW type architecture. Processing core 110 may also be suitable for manufacture in one or more process technologies and by being represented on a machine readable media in sufficient detail, may be suitable to facilitate said manufacture.

Processing core 110 comprises an execution unit 130, a set of register file(s) 150, and a decoder 165. Processing core 110 also includes additional circuitry (not shown) which is not necessary to the understanding of the present invention.

Execution unit 130 is used for executing instructions received by processing core 110. In addition to recognizing typical processor instructions, execution unit 130 recognizes instructions for performing BLEND operations on packed and unpacked data formats. The instruction set recognized by decoder 165 and execution unit 130 may include one or more instructions for BLEND operations, and may also include other packed instructions.

Execution unit 130 is coupled to register file 150 by an internal bus (which may, again, be any type of communication pathway including a multi-drop bus, point-to-point interconnect, etc.). Register file 150 represents a storage area of processing core 110 for storing information, including data. As previously mentioned, it is understood that the storage area used for storing the data is not critical. Execution unit 130 is coupled to decoder 165. Decoder 165 is used for decoding instructions received by processing core 110 into control signals and/or microcode entry points. In response to these control signals and/or microcode entry points. These control signals and/or microcode entry points may be forwarded to the execution unit 130. The execution unit 130 may perform the appropriate operations, responsive to receipt of the control signals and/or microcode entry points. For at least one embodiment, for example, the execution unit 130 may perform the logical comparisons described herein and may also set the status flags as discussed herein or branch to a specified code location, or both.

Processing core 110 is coupled with bus 214 for communicating with various other system devices, which may include but are not limited to, for example, synchronous dynamic random access memory (SDRAM) control 271, static random access memory (SRAM) control 272, burst flash memory interface 273, personal computer memory card international association (PCMCIA)/compact flash (CF) card control 274, liquid crystal display (LCD) control 275, direct memory access (DMA) controller 276, and alternative bus master interface 277.

For at least one embodiment, data processing system 102 may also comprise an I/O bridge 290 for communicating with various I/O devices via an I/O bus 295. Such I/O devices may include but are not limited to, for example, universal asynchronous receiver/transmitter (UART) 291, universal serial bus (USB) 292, Bluetooth wireless UART 293 and I/O expansion interface 294. As with the other buses discussed above, I/O bus 295 may be any type of communication pathway, include a multi-drop bus, point-to-point interconnect, etc.

At least one embodiment of data processing system 102 provides for mobile, network and/or wireless communications and a processing core 110 capable of performing BLEND operations on both packed and unpacked data. Processing core 110 may be programmed with various audio, video, imaging and communications algorithms including discrete transformations, filters or convolutions; compression/decompression techniques such as color space transformation, video encode motion estimation or video decode motion compensation; and modulation/demodulation (MODEM) functions such as pulse coded modulation (PCM).

FIG. 1c illustrates alternative embodiments of a data processing system 103 capable of performing BLEND operations on packed and unpacked data. In accordance with one alternative embodiment, data processing system 103 may include a chip package 310 that includes main processor 224, and one or more coprocessors 226. The optional nature of additional coprocessors 226 is denoted in FIG. 1c with broken lines. One or more of the coprocessors 226 may be, for example, a graphics co-processor capable of executing SIMD instructions.

FIG. 1c illustrates that the data processor system 103 may also include a cache memory 278 and an input/output system 265, both coupled to the chip package 310. The input/output system 295 may optionally be coupled to a wireless interface 296.

Coprocessor 226 is capable of performing general computational operations and is also capable of performing SIMD operations. For at least one embodiment, the coprocessor 226 is capable of performing BLEND operations on packed and unpacked data.

For at least one embodiment, coprocessor 226 comprises an execution unit 130 and register file(s) 209. At least one embodiment of main processor 224 comprises a decoder 165 to recognize and decode instructions of an instruction set that includes BLEND instructions for execution by execution unit 130. For alternative embodiments, coprocessor 226 also comprises at least part of decoder 166 to decode instructions of an instruction set that includes BLEND instructions. Data processing system 103 also includes additional circuitry (not shown) which is not necessary to the understanding of the present invention.

In operation, the main processor 224 executes a stream of data processing instructions that control data processing operations of a general type including interactions with the cache memory 278, and the input/output system 295. Embedded within the stream of data processing instructions are coprocessor instructions. The decoder 165 of main processor 224 recognizes these coprocessor instructions as being of a type that should be executed by an attached coprocessor 226. Accordingly, the main processor 224 issues these coprocessor instructions (or control signals representing the coprocessor instructions) on the coprocessor interconnect 236 where from they are received by any attached coprocessor(s). For the single-coprocessor embodiment illustrated in FIG. 1c, the coprocessor 226 accepts and executes any received coprocessor instructions intended for it. The coprocessor interconnect may be any type of communication pathway, including a multi-drop bus, point-to-pointer interconnect, or the like.

Data may be received via wireless interface 296 for processing by the coprocessor instructions. For one example, voice communication may be received in the form of a digital signal, which may be processed by the coprocessor instructions to regenerate digital audio samples representative of the voice communications. For another example, compressed audio and/or video may be received in the form of a digital bit stream, which may be processed by the coprocessor instructions to regenerate digital audio samples and/or motion video frames.

For at least one alternative embodiment, main processor 224 and a coprocessor 226 may be integrated into a single processing core comprising an execution unit 130, register file(s) 209, and a decoder 165 to recognize instructions of an instruction set that includes BLEND instructions for execution by execution unit 130.

FIG. 2a illustrates the register file of the processor according to one embodiment of the invention. The register file 150 may be used for storing information, including control/status information, integer data, floating point data, and packed data. One of skill in the art will recognize that the foregoing list of information and data is not intended to be an exhaustive, all-inclusive list.

For the embodiment shown in FIG. 2a, the register file 150 includes integer registers 201, registers 209, status registers 208, and instruction pointer register 211. Status registers 208 indicate the status of processor 109, and may include various status registers. Instruction pointer register 211 stores the address of the next instruction to be executed. Integer registers 201, registers 209, status registers 208, and instruction pointer register 211 are all coupled to internal interconnect 170. Additional registers may also be coupled to internal interconnect 170. The internal interconnect 170 may be, but need not necessarily be, a multi-drop bus. The internal interconnect 170 may instead may be any other type of communication pathway, including a point-to-point interconnect.

For one embodiment, the registers 209 may be used for both packed data and floating point data. In one such embodiment, the processor 109, at any given time, treats the registers 209 as being either stack referenced floating point registers or non-stack referenced packed data registers. In this embodiment, a mechanism is included to allow the processor 109 to switch between operating on registers 209 as stack referenced floating point registers and non-stack referenced packed data registers. In another such embodiment, the processor 109 may simultaneously operate on registers 209 as non-stack referenced floating point and packed data registers. As another example, in another embodiment, these same registers may be used for storing integer data.

Of course, alternative embodiments may be implemented to contain more or less sets of registers. For example, an alternative embodiment may include a separate set of floating point registers for storing floating point data. As another example, an alternative embodiment may including a first set of registers, each for storing control/status information, and a second set of registers, each capable of storing integer, floating point, and packed data. As a matter of clarity, the registers of an embodiment should not be limited in meaning to a particular type of circuit. Rather, a register of an embodiment need only be capable of storing and providing data, and performing the functions described herein.

The various sets of registers (e.g., the integer registers 201, the registers 209) may be implemented to include different numbers of registers and/or to different size registers. For example, in one embodiment, the integer registers 201 are implemented to store thirty-two bits, while the registers 209 are implemented to store eighty bits (all eighty bits are used for storing floating point data, while only sixty-four are used for packed data). In addition, registers 209 may contain eight registers, R₀ 212a through R₇ 212h. R₁ 212b, R₂ 212c and R₃ 212d are examples of individual registers in registers 209. Thirty-two bits of a register in registers 209 can be moved into an integer register in integer registers 201. Similarly, a value in an integer register can be moved into thirty-two bits of a register in registers 209. In another embodiment, the integer registers 201 each contain 64 bits, and 64 bits of data may be moved between the integer register 201 and the registers 209. In another alternative embodiment, the registers 209 each contain 64 bits and registers 209 contains sixteen registers. In yet another alternative embodiment, registers 209 contains thirty-two registers.

FIG. 2b illustrates the register file of the processor according to one alternative embodiment of the invention. The register file 150 may be used for storing information, including control/status information, integer data, floating point data, and packed data. In the embodiment shown in FIG. 2b, the register file 150 includes integer registers 201, registers 209, status registers 208, extension registers 210, and instruction pointer register 211. Status registers 208, instruction pointer register 211, integer registers 201, registers 209, are all coupled to internal interconnect 170. Additionally, extension registers 210 are also coupled to internal interconnect 170. The internal interconnect 170 may be, but need not necessarily be, a multi-drop bus. The internal interconnect 170 may instead may be any other type of communication pathway, including a point-to-point interconnect.

For at least one embodiment, the extension registers 210 are used for both packed integer data and packed floating point data. For alternative embodiments, the extension registers 210 may be used for scalar data, packed Boolean data, packed integer data and/or packed floating point data. Of course, alternative embodiments may be implemented to contain more or less sets of registers, more or less registers in each set or more or less data storage bits in each register without departing from the broader scope of the invention.

For at least one embodiment, the integer registers 201 are implemented to store thirty-two bits, the registers 209 are implemented to store eighty bits (all eighty bits are used for storing floating point data, while only sixty-four are used for packed data) and the extension registers 210 are implemented to store 128 bits. In addition, extension registers 210 may contain eight registers, XR₀ 213a through XR₇ 213h. XR₀ 213a, XR₁ 213b and XR₂ 213c are examples of individual registers in registers 210. For another embodiment, the integer registers 201 each contain 64 bits, the extension registers 210 each contain 64 bits and extension registers 210 contains sixteen registers. For one embodiment two registers of extension registers 210 may be operated upon as a pair. For yet another alternative embodiment, extension registers 210 contains thirty-two registers.

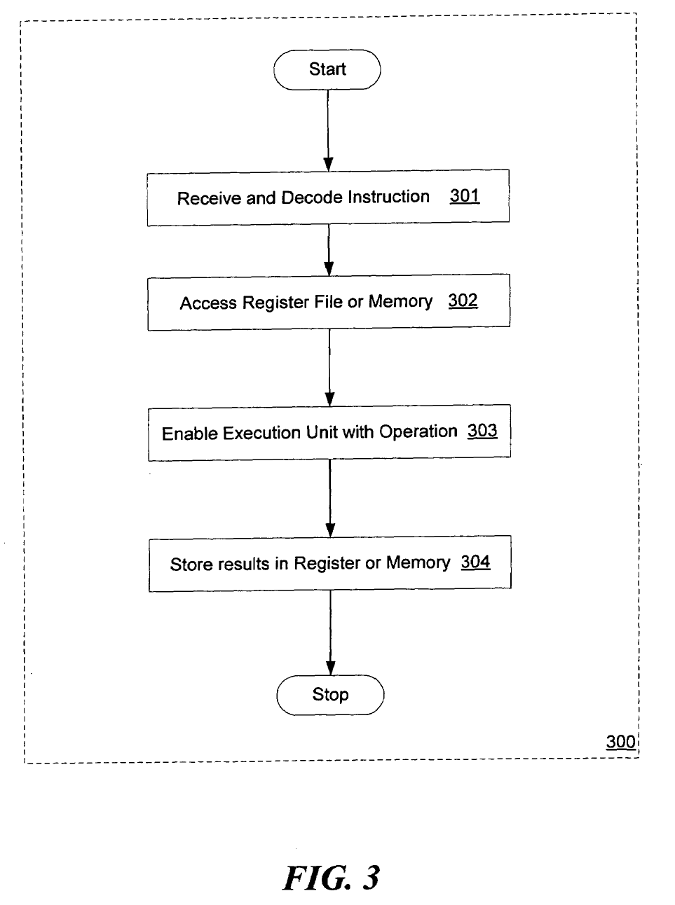

FIG. 3 illustrates a flow diagram for one embodiment of a process 300 to manipulate data according to one embodiment of the invention. That is, FIG. 3 illustrates the process followed, for example, by processor 109 (see, e.g., FIG. 1a) while performing a BLEND operation on packed data, performing a BLEND operation on unpacked data, or performing some other operation. Process 300 and other processes herein disclosed are performed by processing blocks that may comprise dedicated hardware or software or firmware operation codes executable by general purpose machines or by special purpose machines or by a combination of both.

FIG. 3 illustrates that processing for the method begins at “Start” and proceeds to processing block 301. At processing block 301, the decoder 165 (see, e.g., FIG. 1a) receives a control signal from either the cache 160 (see, e.g., FIG. 1a) or interconnect 101 (see, e.g., FIG. 1a). The control signal received at block 301 may be, for at least one embodiment, a type of control signal commonly referred to as a software “instruction.” Decoder 165 decodes the control signal to determine the operations to be performed. Processing proceeds from processing block 301 to processing block 302.

At processing block 302, decoder 165 accesses the register file 150 (FIG. 1a), or a location in memory (see, e.g., main memory 104 or cache memory 160 of FIG. 1a). Registers in the register file 150, or memory locations in the memory, are accessed depending on the register address specified in the control signal. For example, the control signal for an operation can include SRC1, SRC2 and DEST register addresses. SRC1 is the address of the first source register. SRC2 is the address of the second source register. In some cases, the SRC2 address is optional as not all operations require two source addresses. If the SRC2 address is not required for an operation, then only the SRC1 address is used. DEST is the address of the destination register where the result data is stored. For at least one embodiment, SRC1 or SRC2 may also used as DEST in at least one of the control signals recognized by the decoder 165.

The data stored in the corresponding registers is referred to as Source1, Source2, and Result respectively. In one embodiment, each of these data may be sixty-four bits in length. For alternative embodiments, one or more of these data may be other lengths, such as one hundred twenty-eight bits in length.

For another embodiment of the invention, any one, or all, of SRC1, SRC2 and DEST, can define a memory location in the addressable memory space of processor 109 (FIG. 1a) or processing core 110 (FIG. 1b). For example, SRC1 may identify a memory location in main memory 104, while SRC2 identifies a first register in integer registers 201 and DEST identifies a second register in registers 209. For simplicity of the description herein, the invention will be described in relation to accessing the register file 150. However, one of skill in the art will recognize that these described accesses may be made to memory instead.

From block 302, processing proceeds to processing block 303. At processing block 303, execution unit 130 (see, e.g., FIG. 1a) is enabled to perform the operation on the accessed data.

Processing proceeds from processing block 303 to processing block 304. At processing block 304, the result is stored back into register file 150 or memory according to requirements of the control signal. Processing then ends at “Stop”.

### Data Storage Formats

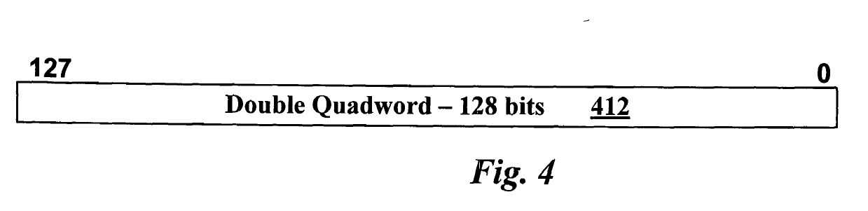

FIG. 4 illustrates packed data-types according to one embodiment of the invention. Four packed and one unpacked data formats are illustrated, including packed byte 421, packed half 422, packed single 423 packed double 424, and unpacked double quadword 412.

The packed byte format 421, for at least one embodiment, is one hundred twenty-eight bits long containing sixteen data elements (B0-B15). Each data element (B0-B15) is one byte (e.g., 8 bits) long.

The packed half format 422, for at least one embodiment, is one hundred twenty-eight bits long containing eight data elements (Half 0 through Half 7). Each of the data elements (Half 0 through Half 7) may hold sixteen bits of information. Each of these sixteen-bit data elements may be referred to, alternately, as a “half word” or “short word” or simply “word.”

The packed single format 423, for at least one embodiment, may be one hundred twenty-eight bits long and may hold four 423 data elements (Single 0 through Single 3). Each of the data elements (Single 0 through Single 3) may hold thirty-two bits of information. Each of the 32-bit data elements may be referred to, alternatively, as a “dword” or “double word”. Each of the data elements (Single 0 through Single 3) may represent, for example, a 32-bit single precision floating point value, hence the term “packed single” format.

The packed double format 424, for at least one embodiment, may be one hundred twenty-eight bits long and may hold two data elements. Each data element (Double 0, Double 1) of the packed double format 424 may hold sixty-four bits of information. Each of the 64-bit data elements may be referred to, alternatively, as a “qword” or “quadword”. Each of the data elements (Double 0, Double 1) may represent, for example, a 64-bit double precision floating point value, hence the term “packed double” format.

The unpacked double quadword format 412 may hold up to 128 bits of data. The data need not necessarily be packed data. For at least one embodiment, for example, the 128 bits of information of the unpacked double quadword format 412 may represent a single scalar datum, such as a character, integer, floating point value, or binary bit-mask value. Alternatively, the 128 bits of the unpacked double quadword format 412 may represent an aggregation of unrelated bits (such as a status register value where each bit or set of bits represents a different flag), or the like.

For at least one embodiment of the invention, the data elements of the packed single 423 and packed double 424 formats may be packed floating point data elements as indicated above. In an alternative embodiment of the invention, the data elements of the packed single 423 and packed double 424 formats may be packed integer, packed Boolean or packed floating point data elements. For another alternative embodiment of the invention, the data elements of packed byte 421, packed half 422, packed single 423 and packed double 424 formats may be packed integer or packed Boolean data elements. For alternative embodiments of the invention, not all of the packed byte 421, packed half 422, packed single 423 and packed double 424 data formats may be permitted or supported.

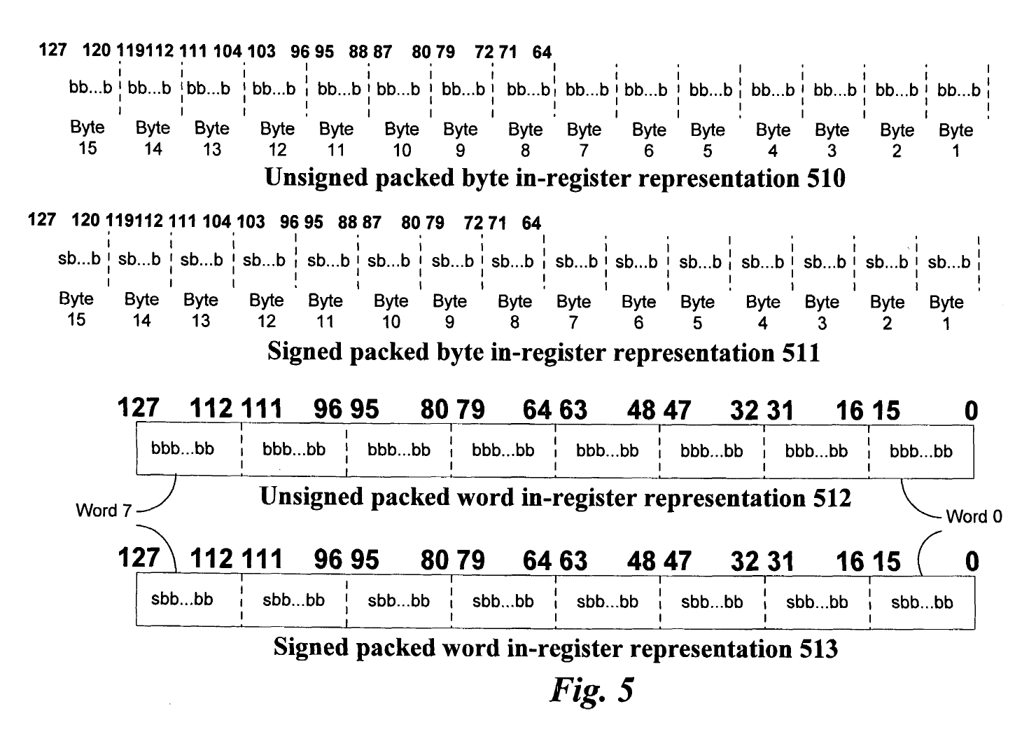

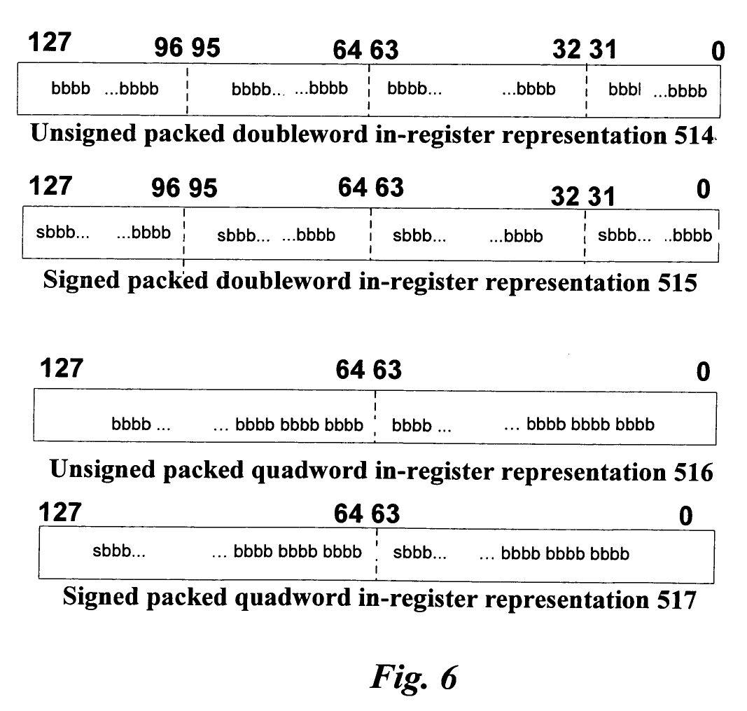

FIGS. 5 and 6 illustrate in-register packed data storage representations according to at least one embodiment of the invention.

FIG. 5 illustrates unsigned and signed packed byte in-register formats 510 and 511, respectively. Unsigned packed byte in-register representation 510 illustrates the storage of unsigned packed byte data, for example in one of the 128-bit extension registers XR₀ 213a through XR₇ 213h (see, e.g., FIG. 2b). Information for each of sixteen byte data elements is stored in bit seven through bit zero for byte zero, bit fifteen through bit eight for byte one, bit twenty-three through bit sixteen for byte two, bit thirty-one through bit twenty-four for byte three, bit thirty-nine through bit thirty-two for byte four, bit forty-seven through bit forty for byte five, bit fifty-five through bit forty-eight for byte six, bit sixty-three through bit fifty-six for byte seven, bit seventy-one through bit sixty-four for byte eight, bit seventy-nine through bit seventy-two for byte nine, bit eighty-seven through bit eighty for byte ten, bit ninety-five through bit eighty-eight for byte eleven, bit one hundred three through bit ninety-six for byte twelve, bit one hundred eleven through bit one hundred four for byte thirteen, bit one hundred nineteen through bit one hundred twelve for byte fourteen and bit one hundred twenty-seven through bit one hundred twenty for byte fifteen.

Thus, all available bits are used in the register. This storage arrangement increases the storage efficiency of the processor. As well, with sixteen data elements accessed, one operation can now be performed on sixteen data elements simultaneously.

Signed packed byte in-register representation 511 illustrates the storage of signed packed bytes. Note that the eighth (MSB) bit of every byte data element is the sign indicator (“s”).

FIG. 5 also illustrates unsigned and signed packed word in-register representations 512 and 513, respectively.

Unsigned packed word in-register representation 512 shows how extension registers 210 store eight word (16 bits each) data elements. Word zero is stored in bit fifteen through bit zero of the register. Word one is stored in bit thirty-one through bit sixteen of the register. Word two is stored in bit forty-seven through bit thirty-two of the register. Word three is stored in bit sixty-three through bit forty-eight of the register. Word four is stored in bit seventy-nine through bit sixty-four of the register. Word five is stored in bit ninety-five through bit eighty of the register. Word six is stored in bit one hundred eleven through bit ninety-six of the register. Word seven is stored in bit one hundred twenty-seven through bit one hundred twelve of the register.

Signed packed word in-register representation 513 is similar to unsigned packed word in-register representation 512. Note that the sign bit (“s”) is stored in the sixteenth bit (MSB) of each word data element.

FIG. 6 illustrates unsigned and signed packed doubleword in-register formats 514 and 515, respectively. Unsigned packed doubleword in-register representation 514 shows how extension registers 210 store four doubleword (32 bits each) data elements. Doubleword zero is stored in bit thirty-one through bit zero of the register. Doubleword one is stored in bit sixty-three through bit thirty-two of the register. Doubleword two is stored in bit ninety-five through bit sixty-four of the register. Doubleword three is stored in bit one hundred twenty-seven through bit ninety-six of the register.

Signed packed double-word in-register representation 515 is similar to unsigned packed quadword in-register representation 516. Note that the sign bit (“s”) is the thirty-second bit (MSB) of each doubleword data element.

FIG. 6 also illustrates unsigned and signed packed quadword in-register formats 516 and 517, respectively. Unsigned packed quadword in-register representation 516 shows how extension registers 210 store two quadword (64 bits each) data elements. Quadword zero is stored in bit sixty-three through bit zero of the register. Quadword one is stored in bit one hundred twenty-seven through bit sixty-four of the register.

Signed packed quadword in-register representation 517 is similar to unsigned packed quadword in-register representation 516. Note that the sign bit (“s”) is the sixty-fourth bit (MSB) of each quadword data element.

### Blend Operations

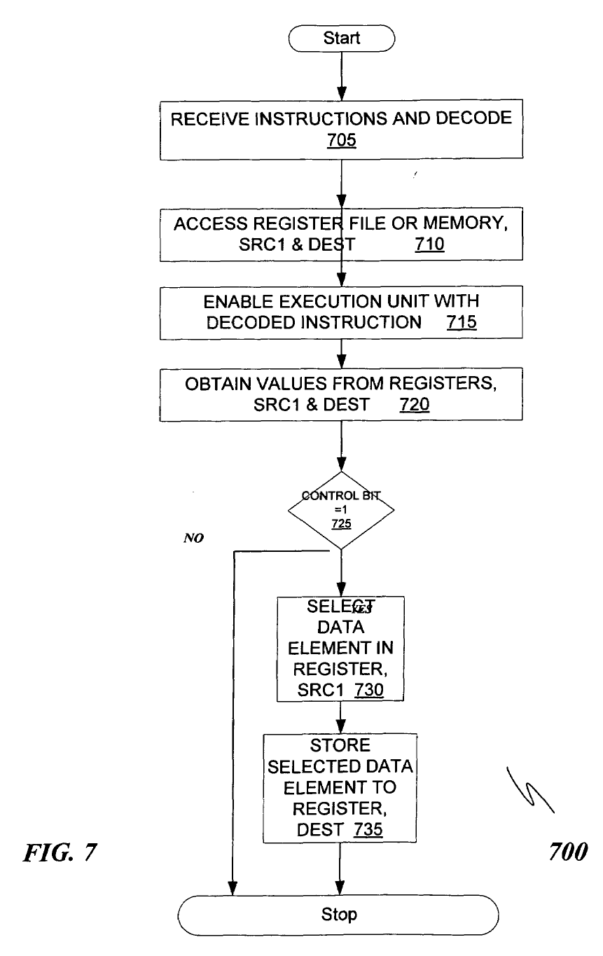

FIG. 7 is a flow chart for a general method 700 for performing BLEND operations according to at least one embodiment of the invention. Process 700 and other processes herein disclosed are performed by processing blocks that may comprise dedicated hardware or software or firmware operation codes executable by general purpose machines or by special purpose machines or by a combination of both.

FIG. 7 illustrates that the method begins at “Start” and proceeds to processing block 705. At processing block 705, decoder 165 decodes the control signal received by the processor 109. Thus, decoder 165 decodes the operation code for a BLEND instruction. Processing then proceeds from processing block 705 to processing block 710.

At processing block 710, via internal bus 170, decoder 165 accesses registers 209 in register file 150 given the SRC1 and DEST addresses encoded in the instruction. For at least one embodiment, the addresses that are encoded in the instruction each indicate an extension register (see, e.g. extension registers 210 of FIG. 2b). For such embodiment, the indicated extension registers 210 are accessed at block 710 in order to provide execution unit 130 with the data stored in the SRC1 register (Source1), and the data stored in the DEST register (Dest). For at least one embodiment, extension registers 210 communicate the data to execution unit 130 via internal bus 170.

From processing block 710, processing proceeds to processing block 715. At processing block 715, decoder 165 enables execution unit 130 to perform the instruction. For at least one embodiment, such enabling 715 is performed by sending one or more control signals to the execution unit to indicate the desired operation (BLEND).

From block 715, processing proceeds to processing block 720. At processing block 720, data stored in the instructions are obtained by the desired operation.

From block 720, processing proceeds to processing block 725. At processing block 725, the processor determines if a control bit is set to “1” for that data element. The data element may vary based on the data storage format. As illustrated in FIG. 4, there are various packed data-types.

The packed byte format 421, for at least one embodiment, is one hundred twenty-eight bits long containing sixteen data elements (B0-B15). Each data element (B0-B15) is one byte (e.g., 8 bits) long.

The packed half format 422, for at least one embodiment, is one hundred twenty-eight bits long containing eight data elements (Half 0 through Half 7). Each of the data elements (Half 0 through Half 7) may hold sixteen bits of information. Each of these sixteen-bit data elements may be referred to, alternately, as a “half word” or “short word” or simply “word.”

The packed single format 423, for at least one embodiment, may be one hundred twenty-eight bits long and may hold four 423 data elements (Single 0 through Single 3). Each of the data elements (Single 0 through Single 3) may hold thirty-two bits of information. Each of the 32-bit data elements may be referred to, alternatively, as a “dword” or “double word”. Each of the data elements (Single 0 through Single 3) may represent, for example, a 32-bit single precision floating point value, hence the term “packed single” format.

The packed double format 424, for at least one embodiment, may be one hundred twenty-eight bits long and may hold two data elements. Each data element (Double 0, Double 1) of the packed double format 424 may hold sixty-four bits of information. Each of the 64-bit data elements may be referred to, alternatively, as a “qword” or “quadword”. Each of the data elements (Double 0, Double 1) may represent, for example, a 64-bit double precision floating point value, hence the term “packed double” format.

For at least one embodiment of the invention, the data elements of the packed 423 and packed double 424 formats may be packed floating point data elements as indicated above. In an alternative embodiment of the invention, the data elements of the packed single 423 and packed double 424 formats may be packed integer, packed Boolean or packed floating point data elements.

For at least one embodiment of the invention, the control bit may refer to the MSB of a data element. The MSB may also be known as a sign indicator or sign bit. For example, the 8^{th} bit (MSB) of every byte data element is a sign indicator; the 16^{th} bit (MSB) of each word data element is a sign bit; the 32^{nd} bit (MSB) of each doubleword data element is a sign bit; and 64^{th} bit (MSB) of each quadword data element is a sign bit.

If the control bit is “1” for the Source1 data element, then processing proceeds to processing block 730. At processing block 730, a multiplexer selects the Source1 data element with control bit “1”. The number of multiplexers depends on the granularity of the instruction. The data element in SRC1 is copied into DEST. The processing proceeds to processing block 735. At block 735, memory stores the selected data element to DEST register. Once stored, the processing ends.

If the control bit is “0”, then processing ends. The data element in DEST remains the same and is not copied.

### Immediate Blend Operations

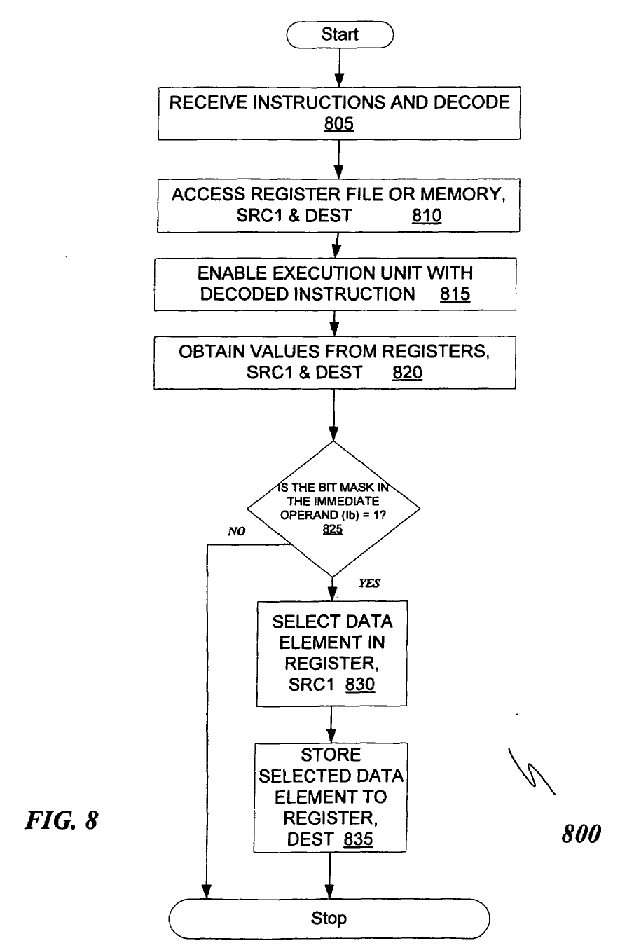

FIG. 8 illustrates a flow diagram for at least one embodiment of a process for an immediate select operation 800 of the general method 700 illustrated in FIG. 7. For the specific embodiment 800 illustrated in FIG. 8, the immediate BLEND operation is performed on Source1 and Dest data values that are 128 bits in length, and which may or may not be packed data. Also, one skilled in the art recognizes that the operations illustrated in FIG. 8 may also be performed for data values of other lengths, including those that are smaller or larger.

Immediate BLEND instructions use bit masks instead of bytes, words or doubleword masks. By using bit masks, this allows for small immediate operands (instead of 64- or 128 bits) so smaller code size and more efficient decoding may occur.

Processing blocks 805 through 820 operate essentially the same for method 800 as do processing blocks 705 through 720 that are described above in connection with method 700, illustrated in FIG. 7. When decoder 165 enables execution unit 130 to perform the instruction at block 815, the instruction is a BLEND instruction for selecting the respective data elements of the Source1 and Dest values.

From processing block 820, processing proceeds to processing block 825. At processing block 825 the following is performed.

For an immediate BLEND instruction, the mnemonics is as follows: BLEND xmm1, xmm2/m128, imm8. The instruction takes 3 operands. The first operand may be the source operand, the second operand maybe the destination operand and the third operand maybe the immediate bit. The immediate BLEND instruction selects values from Source1 (xmm1) and from Dest (xmm2) based on a bit mask. The bit mask may be a bit stored in the immediate field of the data element. The immediate bits (Ib [ ]) maybe used for control purposes and are encoded within the instruction and used as control bits.

From processing block 825, processing proceeds to processing block 830. At processing block 830, if the bit mask in the immediate bit of Source1 is “1”, then the input from Source1 is selected by a multiplexer. As stated previously, the number of multiplexor depends on the granularity of the instruction. The process then proceeds to processing block 835. At processing block 835, the selected input is stored in the final Dest. Thus, if the immediate bit of Source1 is “1”, then that data value is stored in the final Dest.

From processing block 825, processing proceeds to “Stop” if the bit mask in the immediate bit of Source1 is “0” , then, there is no change to the value in Dest. The Source1 data value is not stored in Dest.

Since the immediate BLEND instruction uses immediate operands, it allows a graphics application using static mask patterns to be encoded without requiring any loads for the pattern data. For example, patter fills in graphics applications like Powerpoint, or texture mapping, or twinkling sunlight on water or other animation effects.

The immediate BLEND instruction also provides for quick packing of results where components must be treated differently and the patterns are known in advance. For example, complex numbers or red-green-blue-alpha pixel formats.

Advantageously, since the immediate BLEND instruction does not require a load operation or compare operation to set up the mask, the instruction may work twice as fast.

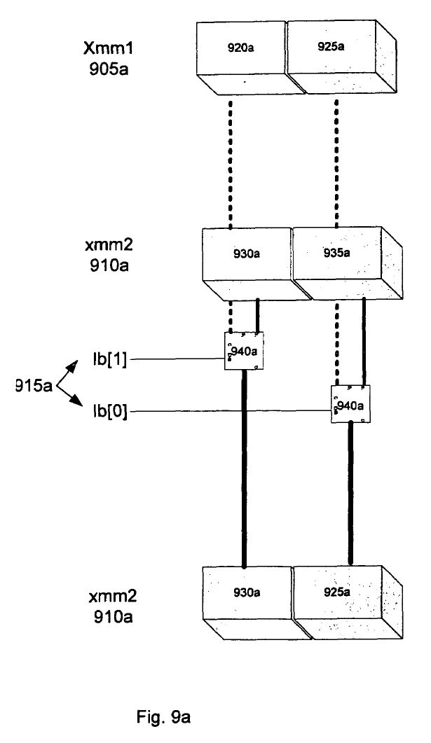

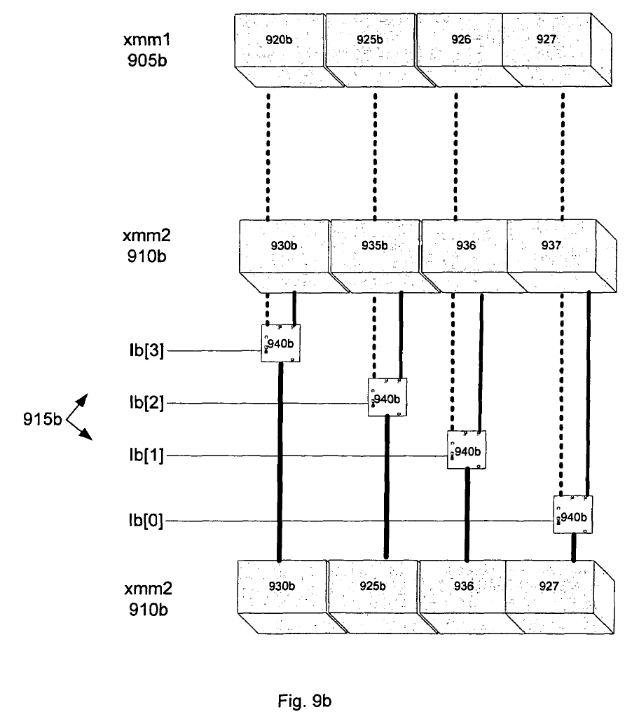

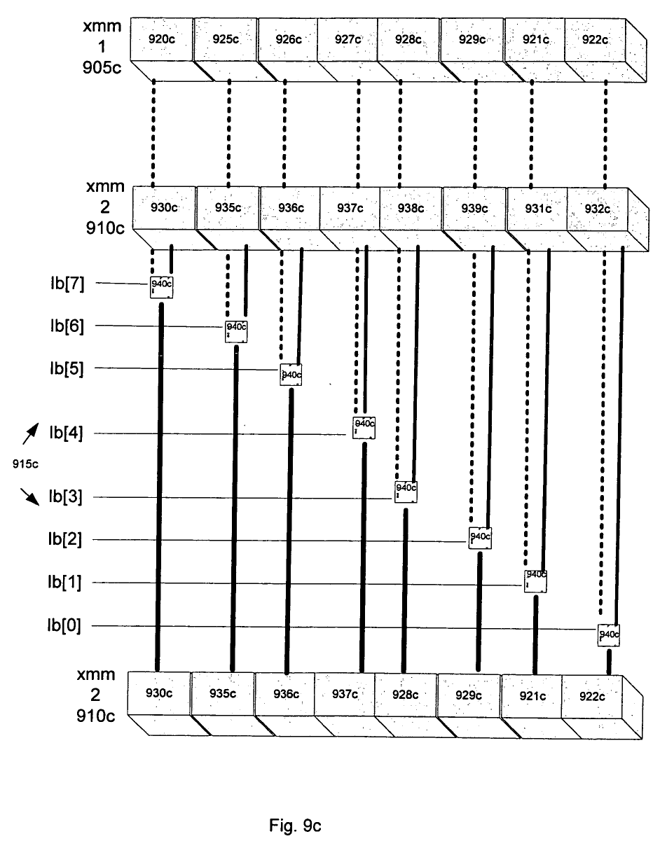

FIG. 9a illustrates a circuit diagram for at least one specific embodiment of a process of the immediate select operation 800 illustrated in FIG. 8. For the specific embodiment illustrated in FIG. 9a, the instruction is a BLEND packed double precision floating point value (BLENDPD). BLENDPD operation is performed on Source1 and Dest data values that are 128 bits in length, and which may or may not be packed data. Also, one skilled in the art recognizes that the operations illustrated in FIG. 9a may also be performed for data values of other lengths, including those that are smaller or larger.

Referring now to FIG. 9a, for a BLENDPD operation, double precision floating point values from a source operand, such as xmm1 905a, may be conditionally written to the destination operand, such as xmm2 910a, depending on the bits in the immediate operand 915a. As stated previously, the immediate bits determine whether the corresponding double precision floating point value in the destination operand is selected and/or copied from the source operand. If an immediate bit in the mask, corresponding to a word is “1”, then the double precision floating point value is selected and/or copied, else the value in the destination remains unchanged.

Since the BLENDPD is a type of packed double precision floating point element, it maybe twenty-eight bits long and may hold two data elements for each xmm register. For example, source operand, xmm1 register, may hold data elements 920a and 925a and destination operand, xmm2 register, may hold data elements 930a and 935a. Each data element of the packed double format 424 may hold sixty-four bits of information. The immediate bit for this instance is Ib[ ] 915a of each data element. A multiplexer 940a selects whether the destination value is copied from the xmm1 register 905a, based on the immediate bit 915a of each data element in the xmm1 register 905.

Referring to FIG. 9a, if the operation is as follows: BLENDPD xmm1, xmm2, 01b. This operation states to place the data element from the source operand whose immediate bit is “1” into the destination register. Since Ib[0] 915a contains bit “1” the data element 925a is selected by the MUX 940a and stored in the destination register 910a. Since Ib[1] 915a contains bit “0”, data element 930a remains the same in the destination register 910a. Upon completion of the operation the final destination register 910a contains data elements 930a and 925a. This value may now be stored in memory.

FIG. 9b illustrates a circuit diagram for at least one specific embodiment of a process of the immediate select operation 800 illustrated in FIG. 8. For the specific embodiment illustrated in FIG. 9b, the instruction is a BLEND packed single precision floating point value (BLENDPS). BLENDPS operation is performed on Source1 and Dest data values that are 128 bits in length, and which may or may not be packed data. Also, one skilled in the art recognizes that the operations illustrated in FIG. 9b may also be performed for data values of other lengths, including those that are smaller or larger.

Referring now to FIG. 9b, for a BLENDPS operation, single precision floating point values from a source operand, such as xmm1 905b, may be conditionally written to the destination operand, such as xmm2 910b, depending on the bits in the immediate operand 915b. As stated previously, the immediate bits determine whether the corresponding double precision floating point value in the destination operand is selected and/or copied from the source operand. If an immediate bit in the mask, corresponding to a word is “1”, then the double precision floating point value is selected by a MUX 940b and copied, else the value in the destination remains unchanged.

Since the BLENDPS is a type of packed single precision floating point element, it maybe twenty-eight bits long and may hold four 423 data elements for each xmm register. For example, source operand, xmm1 register, may hold data elements 920b, 925b, 926b and 927b. The destination operand, xmm2 register, may hold data elements 930b, 935b, 936b and 937b. Each data element of the packed single format 423 may hold thirty-two bits of information. The immediate bit for this instance is Ib[ ] 915b of each data element. A multiplexer 940b selects whether the destination value is copied from the xmm1 register 905b, based on the immediate bit 915b of each data element in the xmm1 register 905b.

Referring to FIG. 9b, if the operation is as follows: BLENDPS xmm1, xmm2, 0101b. This operation states to place the data element from the source operand whose immediate bit is “1” into the destination register. Since Ib[0] 915b contains bit “1” the data element 927b is selected and stored in the destination register 910b. Since Ib[1] 915b contains bit “0”, data element 936b remains the same in the destination register 910b. Ib[2] 915b contains bit “1”, data element 925b is selected and stored in the destination register 910b. Finally, Ib[3] contains bit “0”, data element 930b remains the same in the destination register 910b. Upon completion of the operation the final destination register 910b contains data elements 930b, 925b, 936b and 927b. This value may now be stored in memory.

FIG. 9c illustrates a circuit diagram for at least one specific embodiment of a process of the immediate select operation 800 illustrated in FIG. 8. For the specific embodiment illustrated in FIG. 9c, the instruction is a BLEND packed words (PBLENDDW). PBLENDDW operation is performed on Source1 and Dest data values that are 128 bits in length, and which may or may not be packed data. Also, one skilled in the art recognizes that the operations illustrated in FIG. 9c may also be performed for data values of other lengths, including those that are smaller or larger.

Referring now to FIG. 9c, for a PBLENDDW operation, the word values from a source operand, such as xmm1 905c, may be conditionally written to the destination operand, such as xmm2 910c, depending on the bits in the immediate operand 915c. As stated previously, the immediate bits determine whether the corresponding word value in the destination operand is selected by a multiplexer from the source operand. If an immediate bit in the mask, corresponding to a word is “1”, then the word value is selected and/or copied, else the value in the destination remains unchanged.

Since the PBLENDDW is a type of packed word element, it maybe twenty-eight bits long and may hold eight data elements for each xmm register. For example, source operand, xmm1 register, may hold data elements 920c, 925c, 926c, 927c, 928c, 929c, 921c and 922c. The destination operand, xmm2 register, may hold data elements 930c, 935c, 936c, 937c, 938c, 939c, 931c and 932c. Each data element of the packed double format 422 may hold sixteen bits of information. The immediate bit for this instance is Ib[ ] 915c of each data element. Multiplexers 940c select whether the destination value is copied from the xmm1 register 905c, based on the immediate bit 915c of each data element in the xmm1 register 905c.

Referring to FIG. 9c, if the operation is as follows: PBLENDDW xmm1, xmm2, 00001111b. This operation states to place the data element from the source operand whose immediate bit is “1” into the destination register. Since Ib[0] 915c contains bit “1” the data element 922c is selected by MUX 940c and stored in the destination register 910c. Ib[1] 915c contains bit “1” the data element 921c is selected by MUX 940c and stored in the destination register 910c. Since Ib[2] 915c contains bit “1” the data element 929c is selected by MUX 940c and stored in the destination register 910c. Ib[3] 915c contains bit “1” the data element 928c is selected by MUX 940c and stored in the destination register 910c. Since Ib[4] 915c contains bit “0”, data element 937c remains the same in the destination register 910c. Ib[5] 915c contains bit “0”, data element 936c remains the same in the destination register 910c. Since Ib[6] 915c contains bit “0”, data element 935c remains the same in the destination register 910c. Since Ib[7] 915c contains bit “0”, data element 930c remains the same in the destination register 910c. Upon completion of the operation the final destination register 910c contains data elements 930c, 935c, 936c, 937c, 928c, 929c, 921c and 922c. This value may now be stored in memory.

### Variable Blend Operations

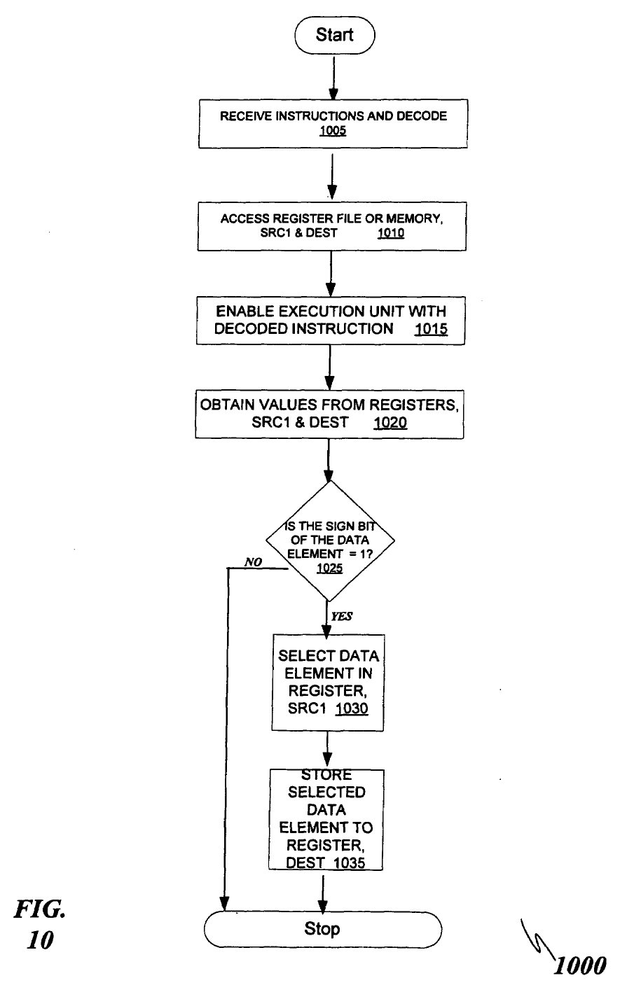

FIG. 10 illustrates a flow diagram for at least one embodiment of a process for an immediate select operation 1000 of the general method 700 illustrated in FIG. 7. For the specific embodiment 1000 illustrated in FIG. 10, the variable BLEND operation is performed on Source1 and Dest data values that are 128 bits in length, and which may or may not be packed data. Also, one skilled in the art recognizes that the operations illustrated in FIG. 10 may also be performed for data values of other lengths, including those that are smaller or larger. In addition, variable BLEND instructions use the sign bit, or most significant bit (MSB) per each data element.

Processing blocks 1005 through 1020 operate essentially the same for method 1000 as do processing blocks 705 through 720 that are described above in connection with method 700, illustrated in FIG. 7. When decoder 165 enables execution unit 130 to perform the instruction at block 1015, the instruction is a BLEND instruction for selecting the respective data elements of the Source 1 and Dest values.

From processing block 1020, processing proceeds to processing block 1025. At processing block 1025 the following is performed.

For a variable BLEND instruction, the mnemonics is as follows: BLEND xmm1, xmm2/m128, <XMM0>. The instruction takes 3 operands. The first operand may be the source operand, the second operand maybe the destination operand and the third operand maybe the control register. The varibale BLEND instruction selects values from Source1 (xmm1) and from Dest (xmm2) based on the most significant bit in an implicit register, xmm0. The control comes from the MSB of each field. The field width corresponds to the field of the instruction type.

From processing block 1025, processing proceeds to processing block 1030. At processing block 1030, if the MSB in the xmm0 register of Source1 is “1”, then the input from Source1 is selected by a multiplexer. As stated previously, the number of multiplexers depends on the granularity of the instruction. The process then proceeds to processing block 1035. At processing block 1035, the selected input is stored in the final Dest. Thus, if the MSB of Source1 is “1”, then that data value is stored in the final Dest.

From processing block 1025, processing proceeds to “Stop” if the MSB of Source1 is “0”, then, there is no change to the value in Dest. The Source1 data value is not stored in Dest.

Since the variable BLEND operation uses the MSB of each field it allows the use of any arithmetic results (floating point or integer) as masks. It also allows the use of comparison results (e.g. 32 bit floating point z-buffer operations can be used to mask 32 bit pixels).

Advantageously, the variable BLEND operation allows masks to be designed for multiple purposes (such as animation effects). The most significant bit could be used first, then shift the mask to the left and use the second most significant bit, then the third, etc. By utilizing this technique, pre-computed sequences of masks, load operations and storage could be greatly reduced.

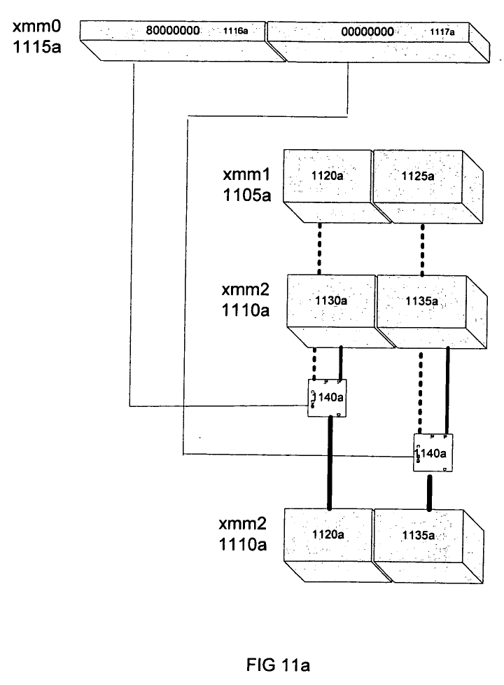

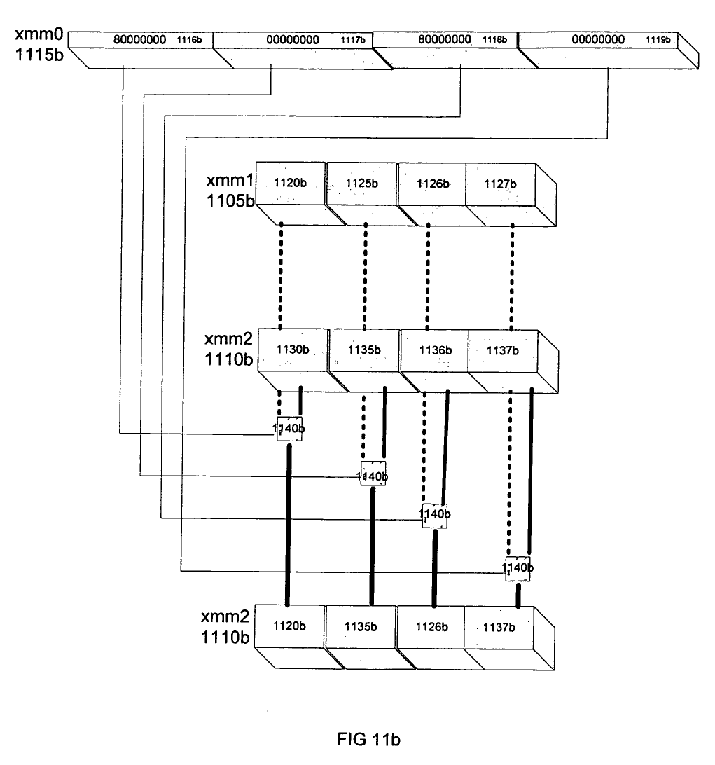

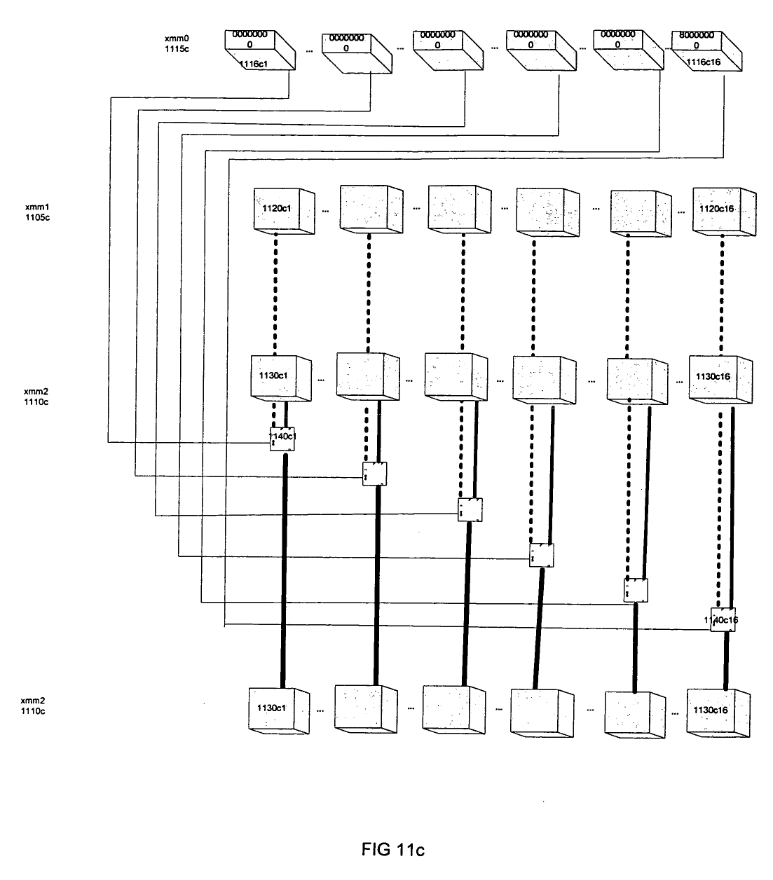

FIG. 11a illustrates a circuit diagram for at least one specific embodiment of a process of the variable select operation 1000 illustrated in FIG. 10. For the specific embodiment illustrated in FIG. 11a, the instruction is a variable BLEND packed double precision floating point value (BLENDVPD). BLENDVPD operation is performed on Source1 and Dest data values that are 128 bits in length, and which may or may not be packed data. Also, one skilled in the art recognizes that the operations illustrated in FIG. 11a may also be performed for data values of other lengths, including those that are smaller or larger.

Referring now to FIG. 11a, for a BLENDVPD operation, double precision floating point values from a source operand, such as xmm1 1105a, may be conditionally written to the destination operand, such as xmm2 1110a, depending on the MSB in the implicit third register, xmm0 1115a. The register assignment of the third operand may be the architectural register XMM0. As stated previously, the MSB in the implicit third register for each Source1 determines whether the corresponding double precision floating point value in the destination operand is selected and/or copied from the source operand. If the MSB in the mask, corresponds to a “1”, then the double precision floating point value is selected and/or copied, else the value in the destination remains unchanged.

Since the BLENDVPD is a type of packed double precision floating point element, it maybe twenty-eight bits long and may hold two data elements for each xmm register. For example, source operand, xmm1 register 1105a, may hold data elements1 120a and 1125a and destination operand, xmm2 register 1110a, may hold data elements 1130a and 1135a. Each data element of the packed double format 424 may hold sixty-four bits of information. A multiplexer 1140a selects whether the destination value is selected from the xmm1 register 1105a, based on the MSB in register 1115a of each data element in the xmm1 register 1105.

Referring to FIG. 11a, if the operation is as follows: BLENDVPD xmm1, xmm2, <XMM0>. This operation states to place the data element from the source operand whose MSB in implicit register XMM0 is “1” into the destination register. Since the MSB of register XMM0 1117a contains bit “0”, the data element 1125a is not selected by the MUX 1140a. Data element 1135a in register xmm2 1110a remains in the destination register. However, the MSB of register XMM0 1116a contains bit “1, the data element 1120a is selected by the MUX 1140a and stored in the destination register 1110a. Upon completion of the operation the final destination register 1110a contains data elements 1120a and 1135a. This value may now be stored in memory.

FIG. 11b illustrates a circuit diagram for at least one specific embodiment of a process of the variable select operation 1000 illustrated in FIG. 10. For the specific embodiment illustrated in FIG. 11b, the instruction is a variable BLEND packed single precision floating point value (BLENDVPS). BLENDPS operation is performed on Source1 and Dest data values that are 128 bits in length, and which may or may not be packed data. Also, one skilled in the art recognizes that the operations illustrated in FIG. 11b may also be performed for data values of other lengths, including those that are smaller or larger.

Referring now to FIG. 11b, for a BLENDVPS operation, single precision floating point values from a source operand, such as xmm1 1105b, may be conditionally written to the destination operand, such as xmm2 110b, depending on the MSB in the implicit third register, xmm0 1115b. The register assignment of the third operand may be the architectural register XMM0. As stated previously, the MSB in the implicit third register for each Source1 determines whether the corresponding single precision floating point value in the destination operand is selected and/or copied from the source operand. If the MSB in the mask, corresponds to “1”, then the double precision floating point value is selected by a MUX 1140b and copied, else the value in the destination remains unchanged.

Since the BLENDVPS is a type of packed single precision floating point element, it maybe twenty-eight bits long and may hold four 423 data elements for each xmm register. For example, source operand, xmm1 register, may hold data elements 1120b, 1125b, 1126b and 1127b. The destination operand, xmm2 register, may hold data elements 1130b, 1135b, 1136b and 1137b. Each data element of the packed single format 423 may hold thirty-two bits of information. A multiplexer 1140b selects whether the destination value is selected from the xmm1 register 1105b, based on the MSB in register 1115b of each data element in the xmm1 register 1105b.

Referring to FIG. 11b, if the operation is as follows: BLENDVPS xmm1, xmm2, <XMM0>. This operation states to place the data element from the source operand whose MSB in implicit register XMM0 is “1” into the destination register. Since the MSB of register XMM0 1117a contains bit “0” the data element 1127b is not selected by MUX 1140b. The value of destination register 1137b remains unchanged. Since the MSB of register XMM0 1118b contains bit “1”, data element 1126b is selected by the MUX 1140b and stored into the destination register 1110b. The value of destination register 1136b is replaced by the Source operand. The MSB of register XMM0 1117b contains bit “0”, data element 1125b is not selected by MUX 1140b. The value of destination register 1135b remains unchanged. Finally, the MSB of register XMM0 1116b contains bit “1”, data element 1120b is selected by the MUX 1140b. The value of destination register 1130b is replaced by the source operand. Upon completion of the operation the final destination register 1110b contains data elements 1120b, 1135b, 112b and 1137b. This value may now be stored in memory.

FIG. 11c illustrates a circuit diagram for at least one specific embodiment of a process of the variable select operation 1000 illustrated in FIG. 10. For the specific embodiment illustrated in FIG. 11c, the instruction is a variable BLEND packed bytes (PBLENDVB). PBLENDVB operation is performed on Source1 and Dest data values that are 128 bits in length, and which may or may not be packed data. Also, one skilled in the art recognizes that the operations illustrated in FIG. 11c may also be performed for data values of other lengths, including those that are smaller or larger.

Referring now to FIG. 11c, for a PBLENDVB operation, the byte values from a source operand, such as xmm1 1105c, may be conditionally written to the destination operand, such as xmm2 1110c, depending on the MSB in the implicit third register, xmm0 1115c. The register assignment of the third operand may be the architectural register XMM0. As stated previously, the MSB in the implicit third register for each Source1 determines whether the corresponding byte value in the destination operand is selected and/or copied from the source operand. If the MSB in the mask, corresponds to “1”, then the byte value is selected by a MUX 1140c and copied, else the value in the destination remains unchanged.

Since the PBLENDVB is a type of packed byte element, it maybe twenty-eight bits long and may hold sixteen data elements for each xmm register. For example, source operand, xmm1 register, may hold data elements 1120c1 through 1120c16. Where c1 through c16 represent: the sixteen data elements for register xmm1 1105c; the sixteen data elements for register xmm2 1110c; the sixteen multiplexers 1140c; and the sixteen implicit registers XMM0 1115c.

The destination operand, xmm2 register, may hold data elements 1130c1 through 1130c16. Each data element of the packed byte format 421 may hold sixteen bits of information. A multiplexer 1140c selects whether the destination value is selected from the xmm1 register 1105c, based on the MSB in register 1115c of each data element in the xmm1 register 1105c.

Referring to FIG. 11c, if the operation is as follows: PBLENDVB xmm1, xmm2, <XMM0>. This operation states to place the data element from the source operand whose MSB in implicit register XMM0 is “1” into the destination register. As previously stated, the source operand 1120c is selected by MUX 1140c based on the MSB in the implicit register 1115c. If the MSB is “1” then the source operand is selected and copied into the destination register 1110c. If the MSB is “0” then the destination register remains unchanged. The values are then stored in memory.

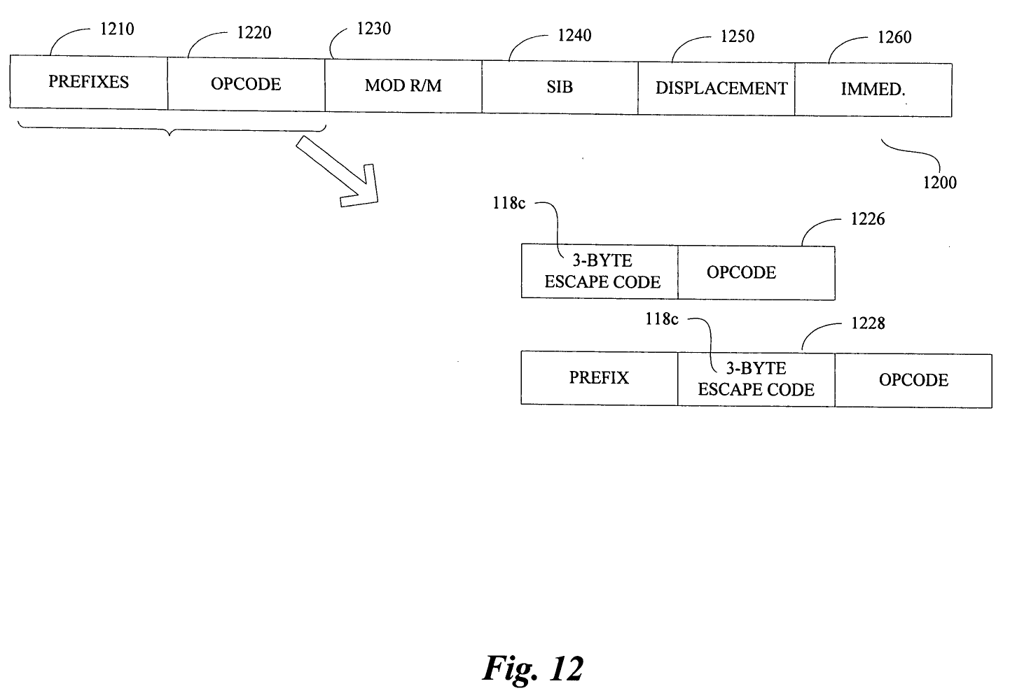

Reference to FIG. 12 illustrates various embodiments of operation codes that may be utilized to encode the control signal (operation code) for a BLEND instruction. FIG. 12 illustrates a format of an instruction 1200 according to one embodiment of the invention. The instruction format 1200 includes various fields; these fields may include a prefix field 1210, an opcode field 1220, and operand specifier fields (e.g., modR/M, scale-index-base, displacement, immediate, etc.). The operand specifier fields are optional and include a modR/M field 1230, an SIB field 1240, a displacement field 1250, and an immediate field 1260.

One skilled in the art will recognize that the format 1200 set forth in FIG. 12 is illustrative, and that other organizations of data within an instruction code may be utilized with disclosed embodiments. For example, the fields 1210, 1220, 1230, 1240, 1250, 1260 need not be organized in the order shown, but may be re-organized into other locations with respect to each other and need not be contiguous. Also, the field lengths discussed herein should not be taken to be limiting. A field discussed as being a particular member of bytes may, in alternative embodiments, be implemented as a larger or smaller field. Also, the term “byte,” while used herein to refer to an eight-bit grouping, may in other embodiments be implemented as a grouping of any other size, including 4 bits, 16 bits, and 32 bits.

As used herein, an opcode for a specific instance of an instruction, such as a BLEND instruction, may include certain values in the fields of the instruction format 200, in order to indicate the desired operation. Such an instruction is sometimes referred to as “an actual instruction.” The bit values for an actual instruction are sometimes referred to collectively herein as an “instruction code.”

For each instruction code, the corresponding decoded instruction code uniquely represents an operation to be performed by an execution unit (such as, e.g., 130 of FIG. 1a) responsive to the instruction code. The decoded instruction code may include one or more micro-operations.

The contents of the opcode field 1220 specify the operation. For at least one embodiment, the opcode field 1220 for the embodiments of the BLEND instructions discussed herein is three bytes in length. The opcode field 1220 may include one, two or three bytes of information. For at least one embodiment, a three-byte escape opcode value in a two-byte escape field 118c of the opcode field 1220 is combined with the contents of a third byte 1225 of the opcode field 1220 to specify an BLEND operation. This third byte 1225 is referenced to herein as an instruction-specific opcode.

For at least one embodiment, the prefix value 0x66 is placed in the prefix field 1210 and is used as part of the instruction opcode to define the desired operation. That is, the value in the prefix 1210 field is decoded as part of the opcode, rather than being construed to merely qualify the opcode that follows. For at least one embodiment, for example, the prefix value 0x66 is utilized to indicate that the destination and source operands of a BLEND instruction reside in 128-bit Intel® SSE2 XMM registers. Other prefixes can be similarly used. However, for at least some embodiments of the BLEND instructions, a prefix may instead be used in the traditional role of enhancing the opcode or qualifying the opcode under some operational condition.

A first embodiment 1226 and a second embodiment 1228 of an instruction format both include a 3-byte escape opcode field 118c and an instruction-specific opcode field 1225. The 3-byte escape opcode field 118c is, for at least one embodiment, two bytes in length. The instruction format 1226 uses one of four special escape opcodes, called three-byte escape opcodes. The three-byte escape opcodes are two bytes in length, and they indicate to decoder hardware that the instruction utilizes a third byte in the opcode field 1220 to define the instruction. The 3-byte escape opcode field 118c may lie anywhere within the instruction opcode and need not necessarily be the highest-order or lowest-order field within the instruction.

Table 1 below, sets forth examples of BLEND instruction codes using prefixes and three-byte escape opcodes.

TABLE 1

| Instruction | Definition |
|---|---|
| BLENDPD xmm1, | Select packed Double Precision Floating Point |
| mxx2/m128, imm8 | values from source xmm1 and destination |
| | xmm2/m128 from mask specified in imm8. Once |
| | selected, store values into xmm1. |
| BLENDPS xmm1, | Select packed Single Precision Floating Point |
| xmm2/m128, imm8 | values from source xmm1 and destination |
| | xmm2/m128 from mask specified in imm8. Once |
| | selected, store values into xmm1. |
| PBLENDDW xmm1, | Select words from xmm1 and xmm2/m128 from |
| xmm2/m128, imm8 | mask specified in imm8. Once selected store |
| | values into xmm1. |
| BLENDVPD xmm1, | Select packed Double Precision Floating Point |
| xmm2/m128, | values from source xmm1 and destination |
| <XMM0> | xmm2/m128 from mask specified in XMM0. |
| | Once selected, store the value into xmm1. |
| BLENDVPS xmm1, | Select packed Single Precision Floating Point |
| xmm2/m128, | values from source xmm1 and destination |
| <XMM0> | xmm2/m128 from mask specified in the high bit |
| | of each single precision floating point number in |
| | XMM0. Once selected, store the value into |
| | xmm1. |
| PBLENDVB xmm1, | Select byte values from xmm1 and xmm2/m128 |
| xmm2/m128, | from mask specified in the high bit of each byte |
| <XMM0> | in XMM0. Once selected, store the value into |
| | xmm1. |

To perform the equivalent of at least some embodiments of the packed BLEND instructions discussed above in connection with FIGS. 7-11, additional instructions are needed, which adds machine cycle latency to the operation. For example, the pseudocode set forth in Table 2, below, illustrates this using a BLEND instruction.

TABLE 2
BLEND instruction

| | |
|---|---|
| movapd | xmm0,xmm7 //x |
| pmaxd | xmm7, XMMWORD PTR |
| _a[eax} | |
| psubd | xmm0, xmm7 |
| psrad | xmm0, 31 |
| pblendv | xmm2, xmm5 |
| paddd | xmm5, xmm3 |

The pseudocode set forth in Table 2 helps to illustrate that the described embodiments of the BLEND instruction can be used to improve the performance of software code. As a result, the BLEND instruction can be used in a general purpose processor to improve the performance of a greater number algorithms than previously done.

### Alternative Embodiments

While the described embodiments use the MSB to signal for various size data elements for the packed embodiments of the BLEND instructions, alternative embodiments may use different sized inputs, different-sized data elements, and/or comparison of different bits (e.g., the LSB of the data elements). In addition, while in some described embodiments Source1 and Dest each contain 128-bits of data, alternative embodiment could operate on packed data having more or less data. For example, one alternative embodiment operates on packed data having 64-bits of data.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting on the invention.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims.

What is claimed is:

1. A method comprising:
receiving an instruction code that is of an instruction format comprising a first field and a second field, the first field to indicate a first multi-bit operand and the second field to indicate a second multi-bit operand; and
modifying the second operand responsive to a sign bit associated with the first operand when the sign bit is non-zero for one or more data element in the first operand.

2. The method of claim 1 further comprising keeping unchanged the data element of the second operand if the sign bit is zero.

3. The method of claim 2, wherein the first operand further comprises a first plurality of data elements including at least A₁ and A₂ as data elements, each having a length of N bits; and
the second operand further comprises a second plurality of data elements including at least B1 and B2, each having a length of N bits.

4. The method of claim 3, wherein the sign bit is an immediate bit stored in the immediate field of the data elements in the first operand.

5. The method of claim 3 wherein the sign bit is the most significant bit in a third operand associated with the first operand.

6. The method of claim 5 wherein the third operand is an implicit register.

7. The method of claim 1 wherein the sign bit controls the flow of data between the first and second operand.

8. The method of claim 2 further comprising storing the first data element from the first operand to the second operand if the sign bit is non-zero.

9. The method of claim 1 wherein the first and second operands each comprises 128 bits.

10. The method of claim 3 where N is 64.

11. The method of claim 1 wherein the one or more data elements are treated as packed byte.

12. The method of claim 1 wherein the one or more data elements are treated as packed word.

13. The method of claim 1, wherein the one or more data elements are treated as double word.

14. The method of claim 1 wherein the one or more data elements are treated as quadword.

15. The apparatus to perform the method of claim 1 comprising:
an execution unit; and
a machine-accessible medium including data that, when accessed by said execution unit, causes the execution unit to perform the method of claim 1.

16. An apparatus comprising:
a first input to receive a first data;
a second input to receive a second data comprising the same number of bits as the first data;
a circuit to, responsive to a first processor instruction, select a first data element from a first operand based on a control bit, where the control bit to select the first data element when the control bit is non-zero.

17. The apparatus of claim 16 wherein the selected first data element to be copied in a second operand.

18. The apparatus of claim 16 wherein the control bit is a sign bit.

19. The apparatus of claim 17 wherein the control bit is an immediate bit stored in the immediate field of the first data element in the first operand.

20. The apparatus of claim 17 wherein the sign bit is the most significant bit in a third operand associated with the first operand.

21. The apparatus of claim 20 wherein the third operand is an implicit register.

22. The apparatus of claim 16 wherein the first and second data each contain at least 128 bits of data.

23. The apparatus of claim 16 wherein the first data further comprises at least two data elements.

24. The apparatus of claim 23 wherein the data elements each comprise 64 bits.

25. The apparatus of claim 16 wherein the first data further comprises at least four data elements.

26. The apparatus of claim 25 wherein the data elements each comprise 32 bits.

27. The apparatus of claim 16, wherein the first data further comprises at least eight data elements.

28. The apparatus of claim 27 wherein the data element each comprise 16 bits.

29. The apparatus of claim 16 wherein the first data further comprises at least sixteen data elements.

30. The apparatus of claim 29 wherein the data element each comprises 8 bits.

31. A computing system comprising:
an addressable memory to store data;
a processor including:
an architecturally-visible storage area to store a control bit;
a decoder to decode an instruction having a first field to specify a N-bit source operand and a second field to specify a N-bit destination operand; an d
an execution unit to, responsive to the decoder decoding the instruction, select a first data element from the source operand based on a control bit, where the control bit to select the first data element when the control bit is non-zero.

32. The computer system of claim 31 wherein N is 128.

33. The computer system of claim 31 wherein the processor to store the first data element in the destination operand.

34. The computer system of claim 31 wherein the control bit is an immediate bit in the first data element.

35. The computer system of claim 31 wherein the control bit is the most significant bit in an third operand.

36. The computer system of claim 35 wherein the third operand is an implicit register.
